(19) United States
(12) Patent Application Publication
(10) Pub. No.: US 2025/0364734 A1
(43) Pub. Date: Nov. 27, 2025

(54) TERMINAL WATERPROOF STRUCTURE

(71) Applicant: Yazaki Corporation, Tokyo (JP)

(72) Inventors: Masahiro Deno, Shizuoka (JP); Hidetaka Hondo, Kanagawa (JP); Yasutaka Miyazaki, Shizuoka (JP)

(73) Assignee: Yazaki Corporation, Tokyo (JP)

(21) Appl. No.: 19/207,649

(22) Filed: May 14, 2025

(30) Foreign Application Priority Data
May 21, 2024 (JP) 2024-082631

(51) Int. Cl. H01R 4/18; H01R 11/11

(52) U.S. Cl. CPC H01R 4/183; H01R 11/11

(57) ABSTRACT

A terminal waterproof structure includes an electric wire, and a terminal attached to a terminal end portion of the electric wire. The terminal includes a terminal connecting portion being formed at a front end portion of the terminal, an electric wire connecting portion in which a core wire exposed from an insulating coating is arranged, the electric wire connecting portion being formed to have a tubular shape on a rear end side of the terminal, and a terminal waterproof portion in which the insulating coating is arranged, the terminal waterproof portion being formed to have a tubular shape at a rear end portion of the terminal. The electric wire connecting portion includes a core wire clamping portion in which the core wire is inserted and clamped. The terminal waterproof portion includes a coating clamping portion in which the insulating coating is inserted and clamped.

### CROSS-REFERENCE TO RELATED APPLICATIONS

The present application is based on, and claims priority from the prior Japanese Patent Application No. 2024-082631, filed on May 21, 2024, the entire contents of which are incorporated herein by reference.

### TECHNICAL FIELD

The present disclosure relates to a terminal waterproof structure.

### BACKGROUND

Hitherto, a charging system including a charging connector and a charging port (charging inlet) has been used to supply power (charge) from outside a vehicle to a battery installed in the vehicle such as an electric automobile and a plug-in hybrid automobile (see JP 2017-220355 A). In the charging inlet described in JP 2017-220355 A, terminals such as a power terminal and a signal terminal are accommodated in a housing, electric wires connected to the terminals are drawn out rearward from the housing, and a retainer collectively prevents those terminals from coming loose.

### SUMMARY OF THE INVENTION

For example, in a charging system in a vehicle such as an electric automobile and a plug-in hybrid automobile, waterproof performance is required to prevent rainwater or the like from infiltrating an inside of a terminal. However, a general terminal waterproof structure (waterproof crimp terminal) in the related art requires processes such as wrapping a connecting point between a terminal and an electric wire with tape or covering the connecting point between the terminal and the electric wire with a heat-shrinkable tube and applying heat thereto.

An object of the present disclosure is to provide a terminal waterproof structure that can improve waterproof performance without using a heat-shrinkable tube or the like.

A terminal waterproof structure according to an embodiment includes an electric wire including a core wire and an insulating coating, and a terminal attached to a terminal end portion of the electric wire. The terminal includes a terminal connecting portion being formed at a front end portion of the terminal and being electrically connected to a mating terminal, an electric wire connecting portion in which the core wire exposed from the insulating coating is arranged, the electric wire connecting portion being formed to have a tubular shape on a rear end side of the terminal, and a terminal waterproof portion in which the insulating coating is arranged, the terminal waterproof portion being adjacent to the electric wire connecting portion and being formed to have a tubular shape at a rear end portion of the terminal. The electric wire connecting portion includes a core wire clamping portion in which the core wire is inserted and clamped. The terminal waterproof portion includes a coating clamping portion in which the insulating coating is inserted and clamped.

According to the above-mentioned configuration, it is possible to provide a terminal waterproof structure that can improve waterproof performance without using a heat-shrinkable tube or the like.

### BRIEF DESCRIPTION OF DRAWINGS

FIG. 1 is an exploded perspective view of a connector to which a terminal waterproof structure according to the present embodiment is applied.

FIG. 2 is a perspective view illustrating an example of the terminal waterproof structure according to the present embodiment.

FIG. 3 is a side cross-sectional view of the terminal waterproof structure according to the present embodiment.

FIG. 4 is a perspective view of a terminal before electric wire crimping.

FIG. 5 is a perspective view of the terminal and an electric wire before electric wire crimping.

### DETAILED DESCRIPTION OF THE INVENTION

With reference to the drawings, a terminal waterproof structure according to the present embodiment is described below in detail. Note that the dimensional ratios in the drawings are exaggerated for explanatory purposes, and may differ from the actual ratios.

The terminal waterproof structure (waterproof crimp terminal) according to the present embodiment is applicable to a charging connector used for charging a battery installed in a vehicle, a charging inlet arranged in a charging port in a vehicle, or the like.

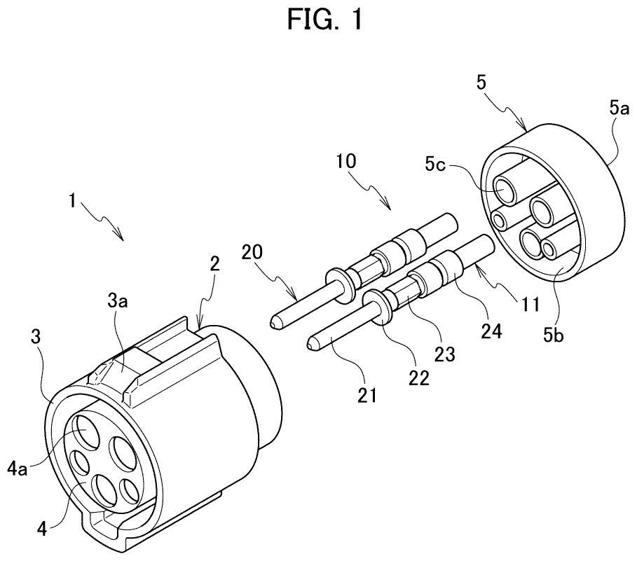

As illustrated in FIG. 1, a connector 1 according to the present embodiment is a charging inlet arranged in a charging port in a vehicle to charge a battery installed in the vehicle. The connector 1 is configured to be fitted with a charging connector (omitted in illustration) provided with a mating terminal (omitted in illustration).

The connector 1 includes a connector housing 2 in which a plurality of terminals 20 are provided and an exterior hood 3 that covers the periphery of the connector housing 2.

The connector housing 2 is configured to include a front housing 4 that is arranged in the exterior hood 3 and is formed of a resin and a terminal holder 5 that is attached to the rear portion of the front housing 4 and is formed of a resin.

The front housing 4 is formed integrally with the exterior hood 3. In the front housing 4, a plurality of terminal accommodation chambers 4a that accommodate the plurality of terminals 20 are formed. Meanwhile, the exterior hood 3 is provided with a locking portion 3a that maintains fitting with the mating terminal (omitted in illustration).

For example, the terminal holder 5 includes a holder main portion 5a that is formed to have a disc-like shape and a holder tube portion 5b that protrudes from the holder main portion 5a toward the front housing and is formed to have a tubular shape. The holder tube portion 5b is formed integrally with the holder main portion 5a.

The holder main portion 5a is provided with a plurality of terminal supporting portions 5c that are provided on an insertion side of a mating connector (omitted in illustration) and support a plurality of terminals. For example, the terminal supporting portion 5c is formed to have a tubular shape, and each terminal supported by the terminal supporting portion 5c is configured by a charging terminal, a signal terminal, an earth terminal, or the like. Further, the terminal supporting portion 5c is formed integrally with the holder main portion 5a.

The connector 1 according to the present embodiment includes a terminal waterproof structure 10.

As illustrated in FIG. 1 to FIG. 3, the terminal waterproof structure 10 according to the present embodiment includes an electric wire 11 and the terminal 20.

The electric wire 11 includes a conductive core wire 12 and an insulating coating 13 that coats the core wire 12. For example, the core wire 12 is configured by bundling a plurality of metal element wires formed of a metal material, such as cupper, having conductivity. The insulating coating 13 is removed at the end portion of the electric wire 11, and the core wire 12 is exposed. The core wire 12 being exposed is crimped to the terminal 20.

The terminal 20 formed of metal (for example, copper) is accommodated in the terminal accommodation chamber 4a. The terminal 20 is also referred to as a crimp terminal. The terminal 20 includes a terminal connecting portion 21 that is formed at the front end portion of the terminal 20 and is electrically connected to the mating terminal (omitted in illustration), and an electric wire connecting portion 23 that is electrically connected to the electric wire 11. Further, the terminal 20 includes a terminal waterproof portion 24 that is formed at the rear end portion of the terminal 20. Moreover, the terminal 20 may include a retaining portion (a flange portion 22) that is provided between the terminal connecting portion 21 and the electric wire connecting portion 23 and is retained in the front housing 4.

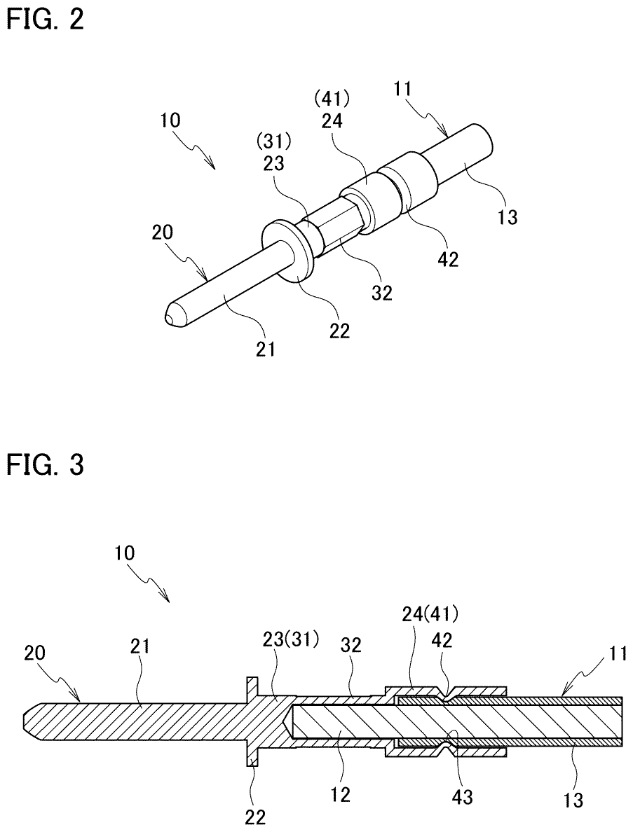

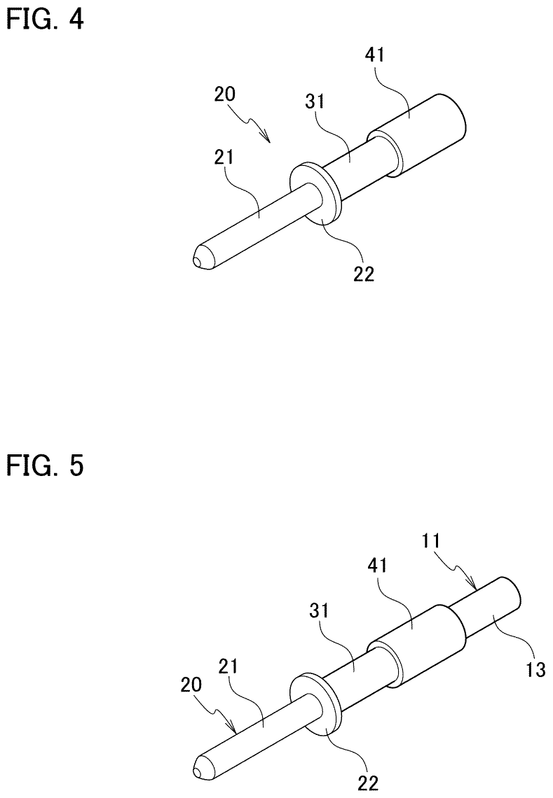

As illustrated in FIG. 2 to FIG. 5, the electric wire connecting portion 23 includes a first barrel portion 31 formed to have a tubular shape. The first barrel portion 31 is provided with a core wire clamping portion 32 having a hexagonal cross-sectional shape. The core wire clamping portion 32 is formed by deforming a part of the first barrel portion 31 (subjecting a part of the first barrel portion 31 to a clamping process). As illustrated in FIG. 5, the core wire clamping portion 32 is formed by, for example, vertical pressing under a state in which the core wire 12 of the electric wire 11 is inserted (press-fitted) into a hole portion of the first barrel portion 31. The method of forming the core wire clamping portion 32 is not limited to vertical pressing.

As illustrated in FIG. 2 to FIG. 5, the terminal waterproof portion 24 includes a second barrel portion 41 formed to have a tubular shape. The second barrel portion 41 is provided with a coating clamping portion 42 formed by deforming a part of the second barrel portion 41 (subjecting a part of the second barrel portion 41 to a clamping process). The coating clamping portion 42 is formed to have an annular shape extending in the circumferential direction of the terminal 20. On the inner circumference of the coating clamping portion 42, a waterproof rib 43 is formed to extend in the circumferential direction of the terminal 20. The waterproof rib 43 functions as a protruding portion for sealing the space between the outer circumference of the insulating coating 13 of the electric wire 11 and the inner circumference of the second barrel portion 41. The coating clamping portion 42 and the waterproof rib 43 are provided over the entire circumference of the coating clamping portion 42 (the second barrel portion 41). Further, the waterproof rib 43 bites into (comes into) the insulating coating 13.

As illustrated in FIG. 5, the coating clamping portion 42 is formed by, for example, vertical pressing simultaneously with formation of the core wire clamping portion 32 under a state in which the insulating coating 13 of the electric wire 11 is inserted into a hole portion of the second barrel portion 41. The method of forming the coating clamping portion 42 is not limited to vertical pressing. The clamping process for the coating clamping portion 42 may not be performed simultaneously with the clamping process for the core wire clamping portion 32.

As described above, the terminal waterproof structure 10 according to an aspect of the present embodiment includes the electric wire 11 including the core wire 12 and the insulating coating 13 and the terminal 20 attached to the terminal end portion of the electric wire 11. The terminal 20 includes the terminal connecting portion 21 that is formed at the front end portion of the terminal 20 and is electrically connected to the mating terminal, and the electric wire connecting portion 23 in which the core wire 12 exposed from the insulating coating 13 is arranged, the electric wire connecting portion 23 being formed to have a tubular shape on the rear end side of the terminal 20. The terminal 20 includes the terminal waterproof portion 24 in which the insulating coating 13 is arranged. The terminal waterproof portion 24 is adjacent to the electric wire connecting portion 23, and is formed to have a tubular shape at the rear end portion of the terminal 20. The electric wire connecting portion 23 includes the core wire clamping portion 32 in which the core wire 12 is inserted and clamped. The terminal waterproof portion 24 includes the coating clamping portion 42 in which the insulating coating 13 is inserted and clamped.

In the present embodiment, the electric wire connecting portion 23 of the terminal 20 is provided with the core wire clamping portion 32 in which the core wire 12 is inserted and clamped, and the terminal waterproof portion 24 is provided with the coating clamping portion 42 in which the insulating coating 13 is inserted and clamped. With this, the terminal waterproof structure 10 is obtained. Further, by the clamping process, the coating clamping portion 42 is formed simultaneously with formation of the core wire clamping portion 32. With this, the terminal waterproof structure 10 according to the present embodiment can be obtained.

According to the present embodiment described above, it is possible to provide the terminal waterproof structure 10 that can improve waterproof performance without using a heat-shrinkable tube or the like.

In the terminal waterproof structure 10, the protruding portion (the waterproof rib 43) may be formed on the inner circumference of the coating clamping portion 42. The protruding portion may extend along the circumferential direction, and may have an annular shape.

The coating clamping portion 42 is thus configured. With this, the space between the outer circumference of the insulating coating 13 of the electric wire 11 and the inner circumference of the terminal waterproof portion 24 (the second barrel portion 41) can be sealed in a watertight manner. Consequently, waterproof performance of the terminal waterproof structure 10 can be improved more.

In the terminal waterproof structure 10, the protruding portion (the waterproof rib 43) may bite into the insulating coating 13.

The waterproof rib 43 on the inner circumference of the coating clamping portion 42 is thus formed. With this, the space between the outer circumference of the insulating coating 13 of the electric wire 11 and the inner circumference of the terminal waterproof portion 24 (the second barrel portion 41) can be sealed in a watertight manner. Consequently, waterproof performance of the terminal waterproof structure 10 can be improved more.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal waterproof structure, comprising:
an electric wire including a core wire and an insulating coating; and
a terminal attached to a terminal end portion of the electric wire, wherein
the terminal includes:
a terminal connecting portion being formed at a front end portion of the terminal and being electrically connected to a mating terminal;
an electric wire connecting portion in which the core wire exposed from the insulating coating is arranged, the electric wire connecting portion being formed to have a tubular shape on a rear end side of the terminal; and
a terminal waterproof portion in which the insulating coating is arranged, the terminal waterproof portion being adjacent to the electric wire connecting portion and being formed to have a tubular shape at a rear end portion of the terminal,
the electric wire connecting portion includes a core wire clamping portion in which the core wire is inserted and clamped, and
the terminal waterproof portion includes a coating clamping portion in which the insulating coating is inserted and clamped.

2. The terminal waterproof structure according to claim 1, wherein
a protruding portion is formed on an inner circumference of the coating clamping portion, the protruding portion extending along a circumferential direction and having an annular shape.

3. The terminal waterproof structure according to claim 2, wherein
the protruding portion bites into the insulating coating.
